(19) United States
(12) Patent Application Publication
(10) Pub. No.: US 2026/0220664 A1
(43) Pub. Date: Jul. 30, 2026

(54) INFORMATION PROCESSING SYSTEM, INFORMATION PROCESSING METHOD, AND NON-TRANSITORY COMPUTER-READABLE MEDIUM

(71) Applicant: PREDICTION INC., Tokyo (JP)

(72) Inventor: Kenichiro OHKI, Tokyo (JP)

(21) Appl. No.: 19/142,635

(22) PCT Filed: Dec. 4, 2023
(86) PCT No.: PCT/JP2023/043326

§ 371 Date: Jun. 24, 2025

(30) Foreign Application Priority Data
Jan. 4, 2023 (JP) 2023-000258

(51) Int. Cl. G06Q 30/0251; G06Q 30/0242; H04L 61/5007

(52) U.S. Cl. CPC G06Q 30/0255; G06Q 30/0246; H04L 61/5007

(57) ABSTRACT

The information processing apparatus includes a control unit. The control unit acquires a plurality of first logs including at least an IP address and a date and time from a first user terminal to which a unique ID is set; retrieve group information from a first database that stores the unique ID and the group information by using the unique ID of the first user terminal as a key; estimate the IP address for the target period based on a regularity of a fluctuation in the IP address if there is the fluctuation in the IP address within a predetermined period in a plurality of the acquired first logs; and store in a second database information that associates at least the estimated IP address with the retrieved group information.

### TECHNICAL FIELD

This disclosure relates to information processing systems, information processing methods, and non-transitory computer readable media.

### BACKGROUND ART

It is known to identify a group to which a user belongs based on an IP (Internet Protocol) address and to use the group information in delivering advertisements. For example, Patent Literature 1 discloses an advertisement delivery apparatus that stores the correspondence between IP addresses and group IDs, and identifies the group ID based on the IP address of a PC terminal to be delivered.

### CITATION LIST

### Patent Literature

### PTL 1

Patent Publication No. 2011-191614

### SUMMARY OF INVENTION

### Technical Problem

The correspondence between a global IP address and a group is known only by the ISP (Internet Service Provider) with which the group has a contract, and it has been difficult for outsiders to accurately identify it. In particular, it has been difficult to accurately identify the correspondence between the group and a dynamic IP address, which changes from one address to another.

The purpose of the present disclosure is to provide an information processing system, an information processing method, and a non-transitory computer readable medium that can achieve the effect of easily identifying the correspondence between a global IP address and a group, in view of the above-mentioned problem.

### Solution to Problem

An information processing system according to an aspect of the present disclosure includes one or more processors, a memory, and one or more programs. The one or more programs are stored in the memory and configured to be executed by the one or more processors to cause the information processing system to: acquire a plurality of first logs including at least an IP address and a date and time from a first user terminal to which a unique ID is set; retrieve group information from a first database that stores the unique ID and the group information by using the unique ID of the first user terminal as a key;
estimate the IP address for the target period based on a regularity of a fluctuation in the IP address if there is the fluctuation in the IP address within a predetermined period in a plurality of the acquired first logs; and store in a second database information that associates at least the estimated IP address with the retrieved group information.

The information processing method according to an aspect of the present disclosure is executed on a computer. The above information processing method includes: acquiring a plurality of first logs including at least an IP address and a date and time from a first user terminal to which a unique ID is set;
retrieving group information from a first database that stores the unique ID and the group information by using the unique ID of the first user terminal as a key; estimating the IP address for the target period based on a regularity of a fluctuation in the IP address if there is the fluctuation in the IP address within a predetermined period in a plurality of the acquired first logs; and storing in a second database information that associates at least the estimated IP address with the retrieved group information.

A non-transitory computer readable medium according to an aspect of the present disclosure stores one or more programs. The one or more programs include instructions that, when executed by a computer, cause the computer to: acquire a plurality of first logs including at least an IP address and a date and time from a first user terminal to which a unique ID is set; retrieve group information from a first database that stores the unique ID and the group information by using the unique ID of the first user terminal as a key; estimate the IP address for the target period based on a regularity of a fluctuation in the IP address if there is the fluctuation in the IP address within a predetermined period in a plurality of the acquired first logs; and store in a second database information that associates at least the estimated IP address with the retrieved group information.

### Advantageous Effects of Invention

This disclosure provides an information processing system, an information processing method, and a non-transitory computer readable medium that can achieve the effect of easily identifying the correspondence between a global IP address and a group.

### BRIEF DESCRIPTION OF DRAWINGS

FIG. 1 is a block diagram of the system for Embodiment 1.

FIG. 2 is a flowchart showing the flow of information processing by the information processing apparatus for Embodiment 1.

FIG. 3 is a block diagram showing the schematic structure of the system for Embodiment 2.

FIG. 4 is a block diagram showing the hardware configuration of the first user terminal according for Embodiment 2.

FIG. 5 is a diagram showing an example of the appearance of the first user terminal according to Embodiment 2.

FIG. 6 is a block diagram showing the hardware configuration of the second user terminal for Embodiment 2.

FIG. 7 is a block diagram showing the hardware configuration of the information processing apparatus for Embodiment 2.

FIG. 8 is a diagram showing an example of the configuration of the memory unit for Embodiment 2.

FIG. 9 is a diagram showing an example of the data structure of the determined table according to Embodiment 2.

FIG. 10 is a diagram showing an example of the data structure of the estimated table for Embodiment 2.

FIG. 11 is a diagram showing an example of the functional configuration of the control unit for Embodiment 2.

FIG. 12 is a flowchart of the registration process by the control unit for Embodiment 2.

FIG. 13 is a flowchart of the second storing process by the control unit according to Embodiment 2.

FIG. 14 is a diagram showing the concept of the second storing process according to Embodiment 2.

FIG. 15 is a flowchart showing the flow of the third storing process by the control unit according to Embodiment 2.

FIG. 16 is a diagram showing the concept of the third storing process according to Embodiment 2.

FIG. 17 is a flowchart showing the flow of the first storing process by the control unit according to Embodiment 2.

FIG. 18 is a diagram showing the concept of the first storing process according to Embodiment 2.

FIG. 19 is a flowchart showing the flow of the generation process by the control unit according to Embodiment 2.

FIG. 20 is a diagram showing a first example of the data structure of the data for analysis according to Embodiment 2.

FIG. 21 is a diagram showing the first example of the data structure of the analysis results according to Embodiment 2.

FIG. 22 is a diagram showing the second example of the data structure of data for analysis according to Embodiment 2.

FIG. 23 is a diagram showing the second example of the data structure of the analysis results according to Embodiment 2.

FIG. 24 is a block diagram showing the schematic structure of the system according to Embodiment 3.

FIG. 25 is a diagram showing an example of the functional configuration of the control unit according to Embodiment 3.

FIG. 26 is a flowchart showing the flow of the comparison process by the control unit according to Embodiment 3.

FIG. 27 is a diagram showing an example of the data structure of the data for measurement according to Embodiment 3.

### DESCRIPTION OF EMBODIMENTS

In the following, embodiments of the present disclosure will be described in detail with reference to the drawings.

In each drawing, identical or corresponding elements are marked with the same symbol, and for clarity of explanation, duplicate explanations will be omitted where necessary.

### Embodiment 1

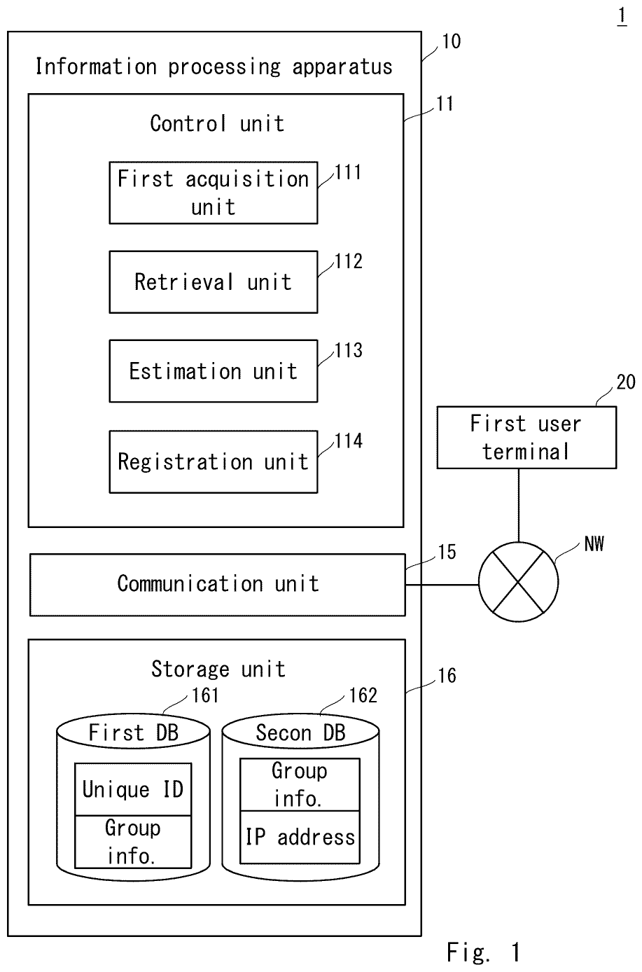

First, Embodiment 1 of this disclosure will be described. FIG. 1 is a block diagram showing the configuration of system 1 for Embodiment 1. The system 1 is a computer system including an information processing apparatus 10 and a first user terminal 20. The information processing apparatus and the first user terminal 20 are communicatively connected via a network NW such as the Internet.

The first user terminal 20 is a terminal belonging to a predefined group, and a unique ID corresponding to the group is preset. The first user terminal 20 belongs to the group when it is installed in a location where the group operates, such as the group's activity area. As an example, the first user terminal 20 may be an image forming device such as a multifunctional printer, a personal computer, a tablet terminal, a smart phone, a wireless LAN router, or a smart speaker.

A group is a group of people who share a purpose, space, etc. For example, a group can be a company, a department, a circle, a family, users of a facility, residents of an apartment building, etc.

Information processing apparatus 10 is a computer that identifies the correspondence between a group and an IP address. For example, information processing apparatus 10 is a server. The IP address is a global IP address. The information processing apparatus 10 has a control unit 11, a communication unit 15, and a storage unit 16.

The control unit 11 has a processor that controls the entire system of the information processing apparatus 10. The control unit 11 executes a program to realize the functions of the first acquisition unit 111, the retrieval unit 112, the estimation unit 113, and the registration unit 114.

The first acquisition unit 111 receives and acquires the measurement log from the first user terminal 20, whose unique ID is known, via the communication unit 15. The measurement log is also referred to as the first log. The measurement log includes at least the IP address of the first user terminal 20 and date and time. The IP address included in the measurement log is the IP address assigned to the first user terminal 20 when it connects to the network NW. The date and time included in the measurement log is the date and time when the first user terminal 20 connects to the network NW, but it may also be the date and time when the information processing apparatus 10 receives the measurement log or when the first user terminal 20 transmits the measurement log. The measurement log may include a unique ID of the first user terminal 20. The first acquisition unit 111 receives the measurement log from the first user terminal 20 at predetermined time intervals. However, instead of this, the first acquisition unit 111 may receive the measurement log from the first user terminal 20 in response to the occurrence of a predetermined event. In this way, the first acquisition unit 111 receives the measurement logs from the first user terminal 20 at regular or irregular intervals, thereby acquiring a plurality of measurement logs at different dates and times.

The retrieval unit 112 retrieves group information from the first DB 161 using the unique ID of the first user terminal 20 that is the source of the measurement log as a key. The group information is any information that can identify the group in which the first user terminal 20 is installed and is not limited to any particular information, but may be a group name, a corporate number, or other public data about the group.

The estimation unit 113 determines whether there is a fluctuation in the IP address within a predetermined period of time in the plurality of measurement logs acquired in the first acquisition unit 111. As an example, the predetermined period is one month, one week, one day, or one hour. If there is a fluctuation in the IP address within the predetermined period, the estimation unit 113 estimates the regularity of the IP address fluctuation. Then, the estimation unit 113 estimates the IP address for the target period based on the estimated regularity of the dynamic IP address fluctuation. The target period may be a future period or a past period.

The registration unit 114 stores, in the second DB 162, information that associates at least the group information retrieved in the retrieval unit 112 and the IP address estimated in the estimation unit 113.

The communication unit 15 is a communication interface for connecting to the network NW. The storage unit 16 is a storage device with a non-transitory computer readable storage medium or an entity storage medium. The storage unit 16 has a first DB 161 and a second DB 162.

The first DB 161 is a storage device that stores a correspondence between unique IDs and group information. The second DB162 is a storage device that stores a correspondence between group information and IP addresses.

Although it is assumed that the first DB 161 and the second DB 162 are included in the storage unit 16 of the information processing apparatus 10, they may be included in an external device accessible by the information processing apparatus 10.

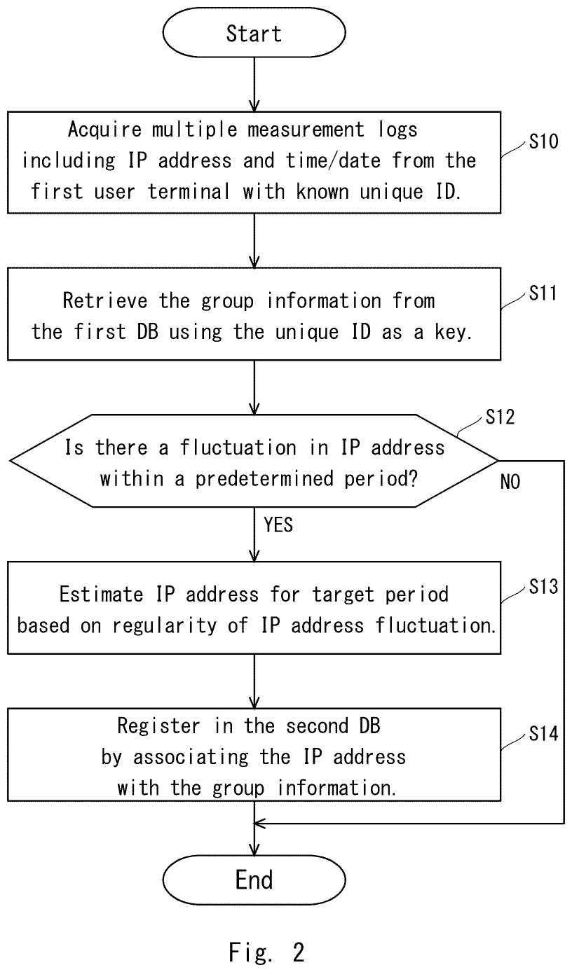

FIG. 2 is a flowchart showing the flow of information processing by the information processing apparatus 10 for Embodiment 1. First, the first acquisition unit 111 acquires a plurality of measurement logs including IP addresses and dates and times from the first user terminal 20 whose unique ID is known (S10: first acquisition step). Next, the retrieval unit 112 accesses the first DB 161 and retrieves group information using the unique ID of the first user terminal 20 from which the measurement logs were transmitted as a key (S11: retrieval step). Next, the estimation unit 113 determines whether or not there is a fluctuation in the IP address within a predetermined period in the multiple measurement logs acquired (S12). If there is a fluctuation in the IP address within the predetermined period (YES in S12), the estimation unit 113 estimates the IP address for the target period based on the regularity of the dynamic IP address fluctuation (S13: estimation step). Next, the registration unit 114 registers, in the second DB162, the information that associates at least the group information retrieved in S11 and the IP address estimated in S13 (S14: first storage step).

### Advantageous Effect

Thus, information processing apparatus 10 estimates the IP address of a group based on the regularity of the IP address fluctuation; where it is particularly difficult to identify the IP address of the group if the IP address is dynamic, Embodiment 1 makes it easy to identify the correspondence between the group and the global IP address.

### Embodiment 2

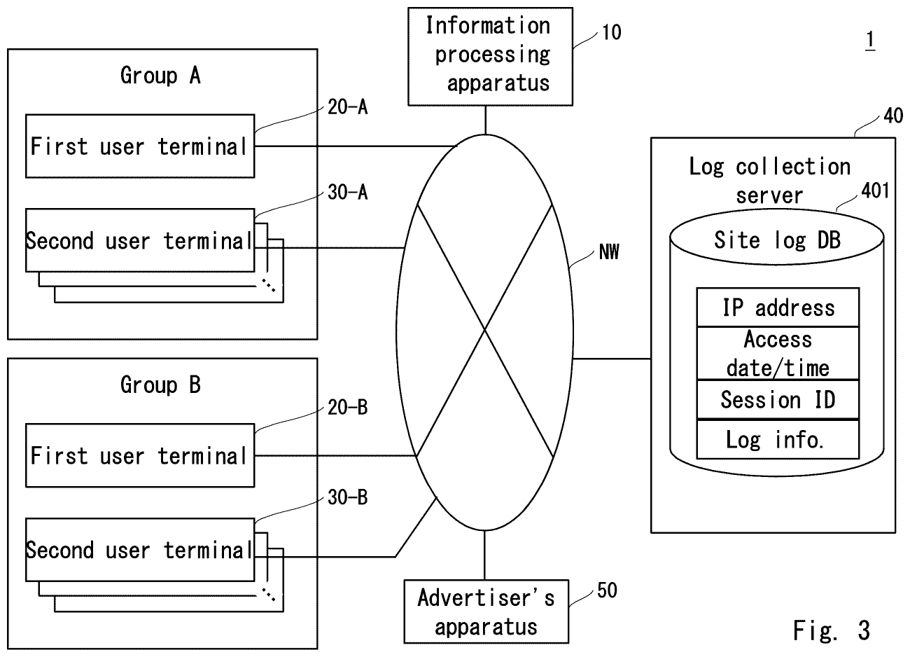

Next, Embodiment 2 of the present disclosure is described. Embodiment 2 is a specific example of Embodiment 1. FIG. 3 is a block diagram showing the schematic configuration of a system 1 for Embodiment 2.

The system 1 includes an information processing apparatus 10, first user terminals 20-A, 20-B, second user terminals 30-A, 30-B, log collection server 40, and advertiser's apparatus 50. These are connected to the network NW and can communicate with each other.

Similar to the information processing apparatus 10 for Embodiment 1, the information processing apparatus 10 for Embodiment 2 identifies the correspondence between groups and IP addresses based on the measurement logs acquired from each of the first user terminals 20-A, 20-B. Furthermore, the information processing apparatus 10 for Embodiment 2 performs an access analysis for each group based on the site logs of when the second user terminals 30-A, 30-B access the advertiser's website and the above correspondence. The information processing apparatus 10 then provides the analysis results to the advertiser's apparatus 50.

The first user terminals 20-A, 20-B are specific examples of the first user terminals 20 according to Embodiment 1. The first user terminals 20-A, 20-B are multifunctional printers with signage installed at different groups “A” and “B”, respectively. The first user terminal 20-A, 20-B is set with a unique ID according to the group. The first user terminals 20-A, 20-B have a function to deliver advertisements.

For example, the first user terminals 20-A, 20-B acquire, from the information processing apparatus 10 or the advertiser's device 50, advertisement data for the group in which they are installed, and display the advertisement data. The first user terminals 20-A, 20-B transmit measurement logs to the information processing apparatus 10 at regular or irregular intervals, respectively.

The second user terminals 30-A and 30-B are terminals used by users (members) belonging to different groups “A” and “B”, respectively. The members may be partners, employees, members or other members of the group. For example, the second user terminals 30-A, 30-B may be personal computers, smartphones or tablet terminals. The second user terminals 30-A, 30-B are not set with a unique ID.

The second user terminals 30-A, 30-B may or may not be mobile.

In the following, the first user terminals 20-A and 20-B are referred to simply as the first user terminal 20 when referring to them without specifying the group. The second user terminals 30-A and 30-B are referred to simply as the second user terminals 30 when referring to them without specifying the group.

The log collection server 40 acquires the site log when the second user terminal 30 accesses the advertiser's website and stores it in the site log DB 401. The log collection server 40 then transmits the site log to the information processing apparatus 10. The site log is also referred to as the second log. The site log includes at least the IP address of when the second user terminal 30 accessed the website, the access date and time, an identifier that directly or indirectly indicates the user who accessed the website, and log information on the web browsing. For example, the above identifier is a user ID, terminal ID, or session ID. The user ID is a unique identifier of the user who accessed the website. The terminal ID is information that identifies the terminal that accessed the website. The session ID is information that uniquely identifies the session of the user who accessed the website. The site log may include device fingerprints including unique information held by the hardware, software or browser of the second user terminal 30. For example, the site log is automatically transmitted to the log collection server 40 by a tag embedded in the advertiser's website accessed by the second user terminal 30.

The advertiser's apparatus 50 is a computer used by the advertiser.

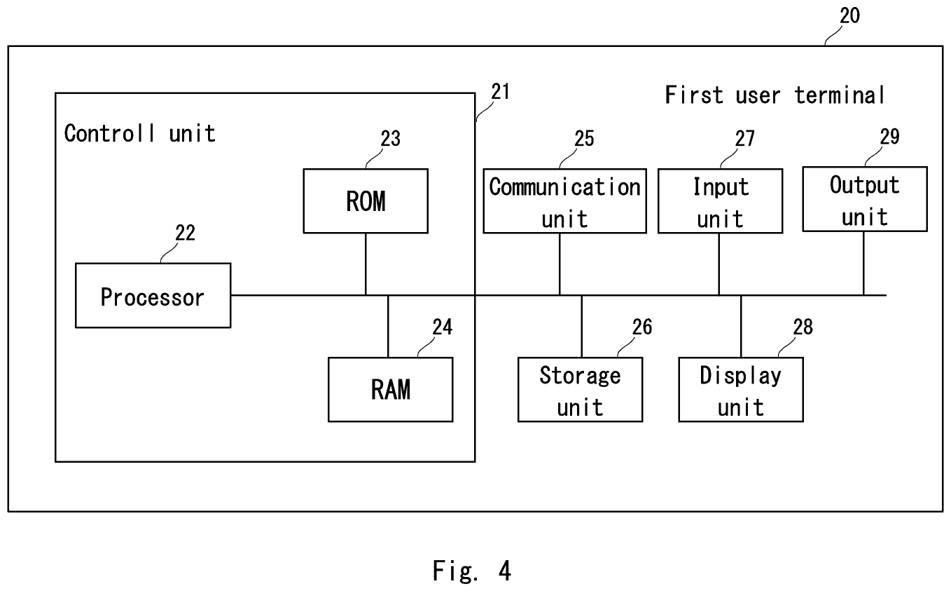

FIG. 4 is a block diagram showing the hardware configuration of the first user terminal 20 for Embodiment 2. The first user terminal 20 has a control unit 21 for controlling the entire system. The control unit 21 is connected to the communication unit 25, storage unit 26, input unit 27, display unit 28, and output unit 29 via a communication bus.

The control unit 21 has a processor 22, ROM 23, and RAM 24. The processor 22 performs various information processing and control according to programs stored in ROM 23 or storage unit 26. ROM 23 is a non-transient storage medium, such as ROM (read-only memory), in which various programs or data for processor 22 to perform various controls or operations are stored in advance. RAM24 is a volatile storage medium such as RAM (Random Access Memory) and is a storage area for temporarily holding information when the processor 22 is operating. In this RAM 24, an area can be reserved for various types of processing according to this embodiment.

The communication unit 25 is a communication interface for connecting to the network NW. The storage unit 26 is a storage device that includes a non-transitory computer readable medium or an entity storage medium.

The input unit 27 is an input device that accepts input from the user, such as a keyboard, mouse, and touch panel. The display unit 28 is a display device such as a CRT, liquid crystal display, organic EL display or plasma display. The output unit 29 is an output device that prints out the results of the information processing by the control unit 21.

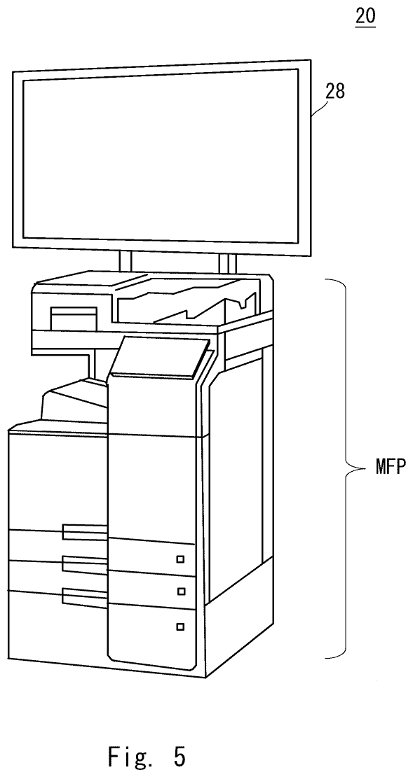

FIG. 5 is a diagram showing an example of the appearance of the first user terminal 20 according to Embodiment 2. The control unit 21, communication unit 25, storage unit 26, input unit 27, and output unit 29 may constitute a general multifunctional printer MFP. And as shown in this figure, the display unit 28 may be an external digital signage.

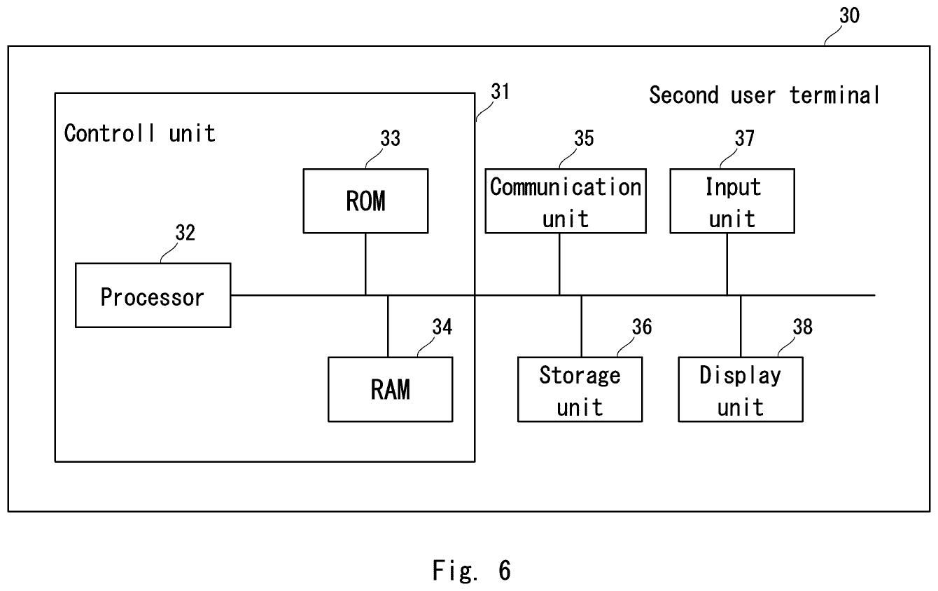

FIG. 6 is a block diagram showing the hardware configuration of the second user terminal 30 for Embodiment 2. The second user terminal 30 has a control unit 31 for controlling the entire system. The control unit 31 are connected to a communication unit 35, a storage unit 36, an input unit 37, and a display unit 38 via a communication bus.

The control unit 31 has a processor 32, ROM 33, and RAM 34. The processor 32 performs various information processing and control according to programs stored in ROM 33 or the storage unit 36. ROM 33 is a non-transitory storage medium, such as ROM, in which various programs or data for the processor 32 to perform various controls or operations are stored in advance. RAM 34 is a volatile storage medium, such as RAM or other volatile storage medium, and is a storage area for temporarily holding information during operation of the processor 32. In this RAM 34, an area can be reserved for various types of processing according to this system.

The communication unit 35 is a communication interface for connecting to the network NW. The storage unit 36 is a storage device that includes a non-transitory computer readable medium or an entity storage medium.

The input unit 37 is an input device that accepts input from the user, such as a keyboard, mouse, and touch panel.

The display unit 38 is a display device such as a CRT, liquid crystal display, organic EL display or plasma display.

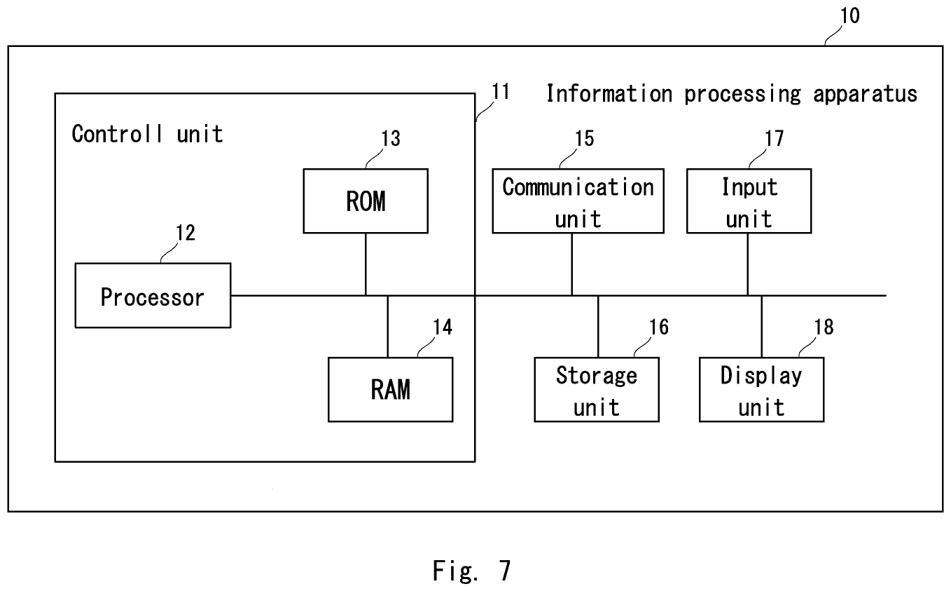

FIG. 7 is a block diagram showing the hardware configuration of information processing apparatus 10 for Embodiment 2. In addition to the control unit 11, the communication unit 15, and the storage unit 16, the information processing apparatus 10 includes an input unit 17 and a display unit 18.

The control unit 11 has a processor 12, ROM 13, and RAM 14. The processor 12 performs various information processing and control according to programs stored in ROM 13 or the storage unit 16.

ROM 13 is a non-transitory storage medium, such as ROM, in which various programs or data for processor 12 to perform various controls or operations are stored in advance. RAM 14 is a volatile storage medium, such as RAM or other volatile storage medium, and is a storage area for temporarily holding information during operation of the processor 12. In this RAM 14, an area can be reserved for various types of processing according to this embodiment.

The input unit 17 is an input device that accepts input from the user, such as a keyboard, mouse, and touch panel. The display unit 18 is a display device such as a CRT, liquid crystal display, organic EL display or plasma display. The input unit 17 and display unit 18 are not required.

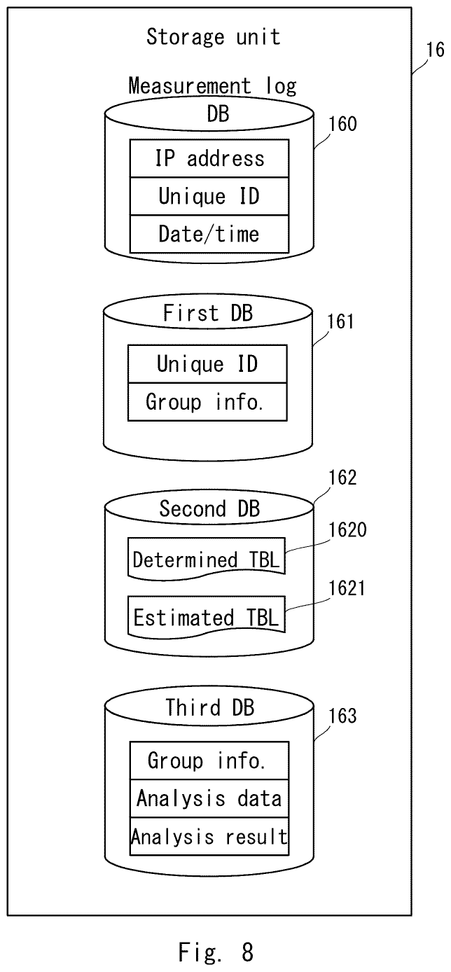

FIG. 8 shows an example of the configuration of the storage unit 16 for Embodiment 2. In addition to the first DB 161 and the second DB 162, the storage unit 16 has a measurement log DB 160 and a third DB 163.

The measurement log DB 160 is a storage device that stores the measurement logs received from the first user terminal 20. The measurement log includes the IP address, a unique ID, a date and time.

The third DB 163 is a storage device that stores group information, data for analysis subject to access analysis, and the results of analysis by the information processing apparatus 10 in correspondence.

The first DB 161 is generated in advance based on known information.

Here in Embodiment 2, the second DB 162 includes a determined table 1620 and an estimated table 1621.

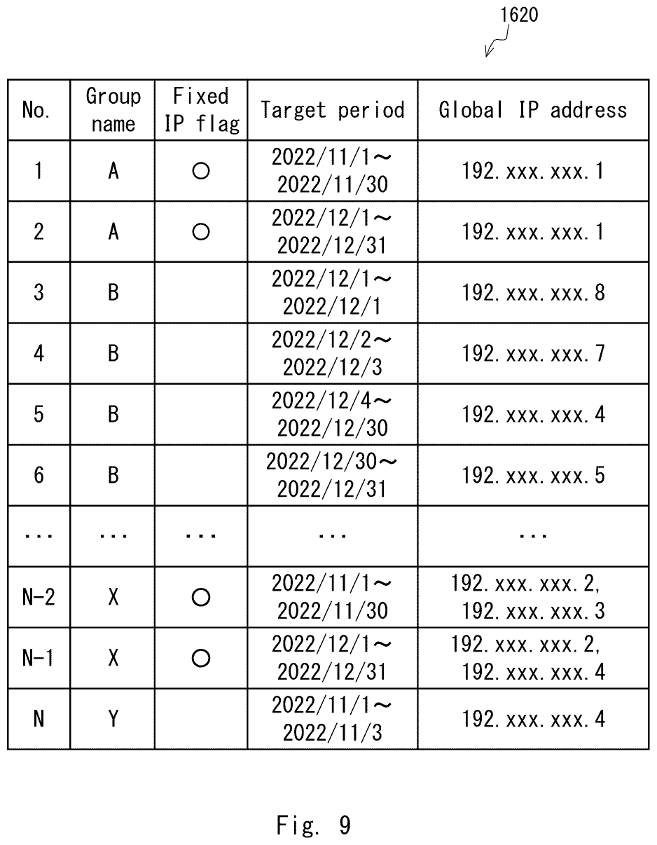

FIG. 9 shows an example of the data structure of the determined table 1620 for Embodiment 2. The determined table 1620 associates a record number, a group name as an example of group information, a fixed IP flag, a target period, with a global IP address.

The record number indicates the order in which the records were registered in the determined table 1620. The fixed IP flag is a variable that indicates whether the global IP address is a fixed IP address or not. For example, if the fixed IP flag is ON, the global IP address is a fixed IP address, and if the fixed IP flag is OFF, the global IP address is a dynamic IP address.

The determined table 1620 is generated by the registration process by the information processing apparatus 10 as described below. However, the determined table 1620 may include records for groups whose IP addresses are known in advance.

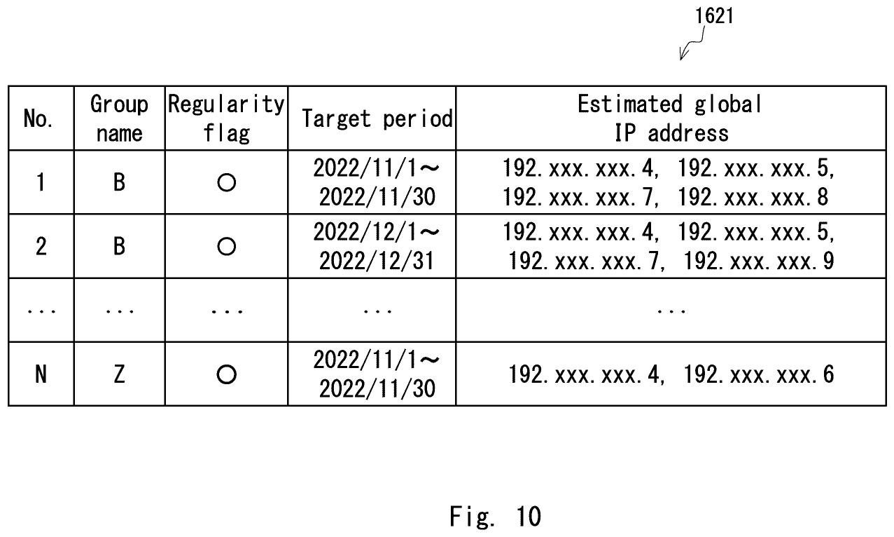

FIG. 10 shows an example of the data structure of the estimated table 1621 for Embodiment 2. The estimated table 1621 associates a record number, a group name as an example of group information, a regularity flag, a target period, and an estimated global IP address.

The record number indicates the order in which the records were registered in the estimated table 1621. The regularity flag is a variable that indicates whether there is a regularity of fluctuations in the global IP address within the measurement period. The estimated global IP address is a global IP address that is estimated to be the IP address of the group in the target period. The estimated global IP address may be a single IP address or may include multiple IP addresses.

The estimated table 1621 is generated by the registration process by the information processing apparatus 10 as described below.

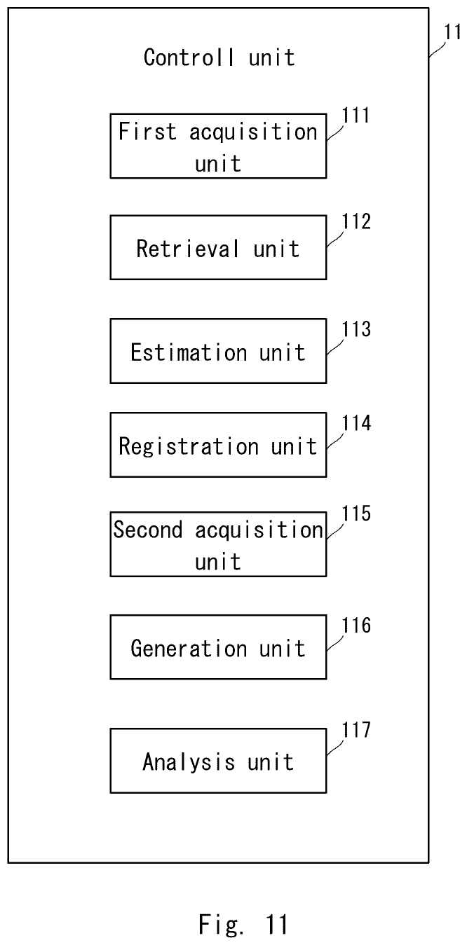

FIG. 11 shows an example of the functional configuration of the control unit 11 for Embodiment 2. The control unit 11 has a second acquisition unit 115, a generation unit 116, and an analysis unit 117, in addition to the first acquisition unit 111, the retrieval unit 112, the estimation unit 113, and the registration unit 114.

The first acquisition unit 111 and the retrieval unit 112 are the same as in Embodiment 1, so a description is omitted.

As in Embodiment 1, the estimation unit 113 determines whether there is a fluctuation in the IP address within a predetermined measurement period in the plurality of measurement logs acquired by the first acquisition unit 111. If there is a fluctuation in the IP address within the measurement period, the estimation unit 113 determines whether or not there is a regularity of the fluctuation in the IP address associated with the unique ID. If there is a regularity of the fluctuation in the IP address, the estimation unit 113 together with the registration unit 114 performs the first storing process described below. The control unit 11 thereby stores, in the estimated table 1621 of the second DB 162, the information that associates at least the estimated IP address with the retrieved group information.

If there is no fluctuation in the IP address within the measurement period, the estimation unit 113, together with the registration unit 114, executes the second storing process described below. The control unit 11 thereby stores, in the determined table 1620 of the second DB 162, the information that associates at least the IP address that has not experienced any dynamic address fluctuation with the retrieved group information as a single record.

On the other hand, if there is a fluctuation in IP address within the measurement period, the estimation unit 113, together with the registration unit 114, executes the third storing process described below. The control unit 11 thereby stores, in the determined table 1620 of the second DB 162, the information that associates at least the IP address included in the measurement log in which the IP address has experienced a dynamic address fluctuation with the retrieved group information as a single record.

The second acquisition unit 115 acquires a site log from the log collection server 40 of when the second user terminal 30 accesses a predetermined website. The predetermined website is, for example, the advertiser's website, but it can be any website that contains content related to the advertiser.

The generating unit 116 identifies, from the second DB 162, group information that is associated with the IP address included in the site log and that corresponds to the access date and time included in the site log. The generation unit 116 generates as data for analysis the information that associates at least the log information on the web browsing included in the site log, the access date and time, with the identified group information. The generation unit 116 stores data for analysis in the third DB163.

The analysis unit 117 performs access analysis based on data for analysis. The analysis unit 117 stores the analysis results in the third DB 163. The analysis unit 117 then transmits the analysis results to the advertiser's device 50 via the communication unit 15.

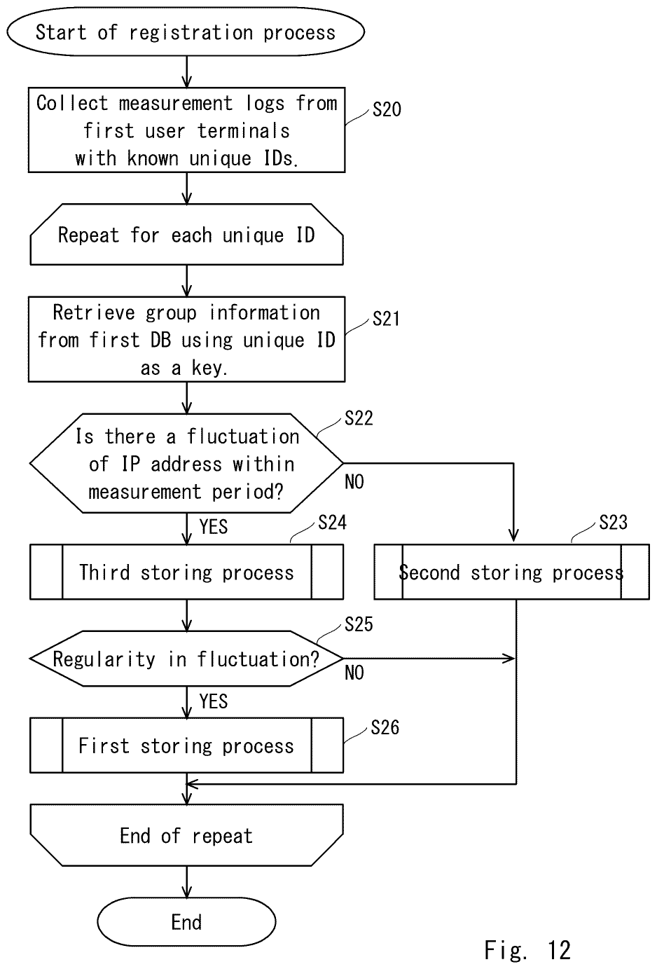

FIG. 12 is a flowchart of the registration process by the control unit 11 for Embodiment 2.

First, the first acquisition unit 111 collects measurement logs including unique IDs IP addresses, and dates and times from the first user terminals 20-A and 20-B, respectively, whose unique IDs are known (S20: first retrieval step). Next, the control unit 11 repeats the process shown in S21 to S26 for each unique ID for the measurement logs extracted for each unique ID of the first user terminal 20 of the transmission source. In S21, the retrieval unit 112 accesses the first DB 161 and retrieves group information using the unique ID as a key (S21: retrieval step) . Next, the estimation unit 113 determines whether or not there is a fluctuation in the IP address within the measurement period in the plurality of measurement logs acquired (S22). No fluctuation in IP address within the measurement period means not only that the IP address does not change at all within the measurement period, but also that there is a fluctuation in IP address within a predetermined range within the measurement period.

If there is no fluctuation in IP address within the measurement period (NO in S22), that is, if the IP address is a fixed IP address, the estimation unit 113 and the registration unit 114 execute the second storing process (S23: second storing step). The control unit 11 then returns the process to S21 if there is an unprocessed unique ID.

On the other hand, if there is a fluctuation in IP address within the measurement period (YES in S22), that is, if the IP address is a dynamic IP address, the estimation unit 113 and the registration unit 114 execute the third storing process (S24: third storing step).

Next, the estimation unit 113 determines whether there is a regularity of the dynamic IP address fluctuation (S25). The estimation unit 113 may determine whether there is a regularity of fluctuation in the IP address based on at least one of the following: the number of times the same IP address appears, the periodicity of appearance of the same IP address, and the dynamic range of fluctuation in the IP address. The estimation unit 113 may also identify the Internet Service Provider (ISP) based on the IP addresses included in the measurement logs where there is a fluctuation in the IP address, and determine whether there is a regularity based on the ISP. This allows the estimation unit 113 to easily estimate the regularity of the fluctuation in the IP address.

If the estimation unit 113 determines that there is the regularity of the fluctuation in the IP address (YES in S25), the estimation unit 113 and the registration unit 114 execute the first storing process (S26). The control unit 11 then returns the process to S21 if there are any unprocessed unique IDs. On the other hand, if it is not determined that there is the regularity of the fluctuation in the IP address (NO in S25), the process returns to S21 if there are any unprocessed unique IDs.

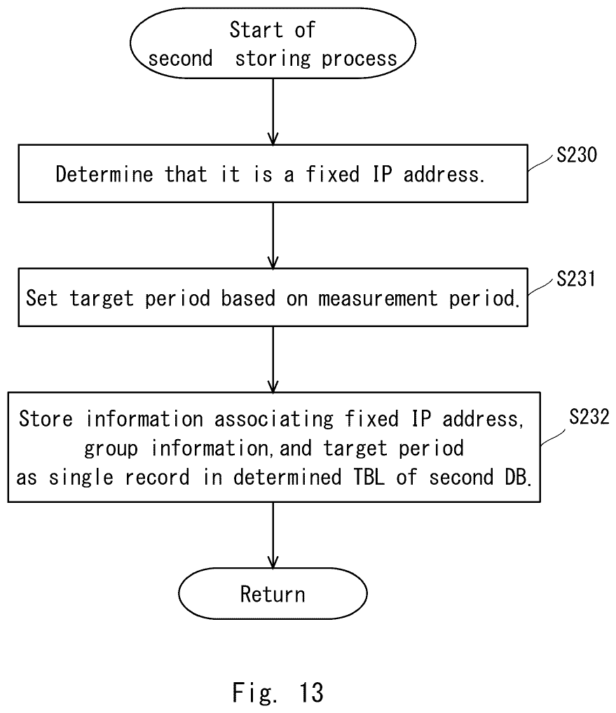

FIG. 13 is a flowchart showing the flow of the second storing process by the control unit 11 according to Embodiment 2. FIG., 14 shows the concept of the second storing process according to Embodiment 2.

The estimation unit 113 determines whether there is the fluctuation in the IP address within the measurement period and, if there is no fluctuation, determines that it is a fixed IP address (S230). As an example, assume the measurement period is from Nov. 1, 2022 to Nov. 30, 2022. Since the IP address of the company “I” is fixed at 198.51.100.1 within this measurement period, the estimation unit 113 turns on the fixed IP flag.

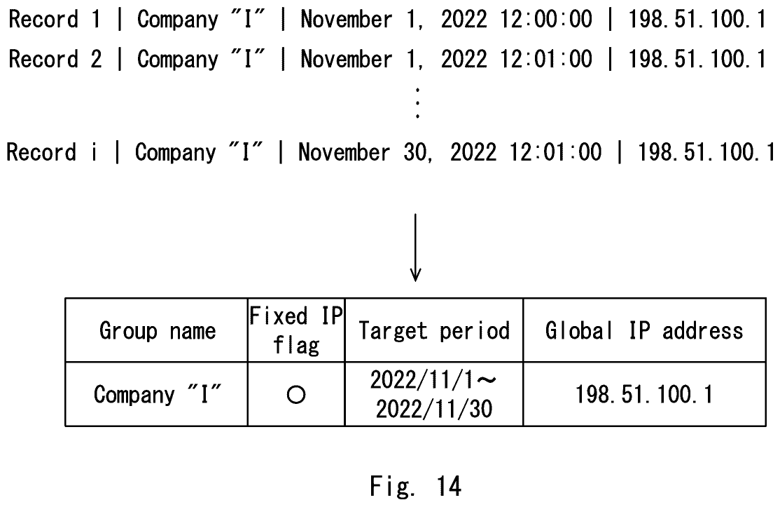

The registration unit 114 then sets the target period based on the measurement period (S231). In the example shown in FIG. 14, the registration unit 114 sets the same period as the measurement period as the target period (Nov. 1, 2022 to Nov. 30, 2022). However, it is not limited to this. For example, the registration unit 114 may set the target period as one month in the future, several months ahead of the measurement period.

The registration unit 114 then stores, in the determined table 1620 of the second DB 162, information that associates the fixed IP address, the retrieved group information, and the target period as single new record (S232). Thus, the registration unit 114 can combine the information of the plurality of measurement logs within a measurement period into a single record. This makes it possible to complement logs for dates and times with no measurement records while reducing data volume stored in the determined table 1620.

The registration unit 114 may also store, in the determined table 1620, information of the plurality of measurement logs within the measurement period as multiple records together with the retrieved group information. In this case, the number of records can be smaller than the number of underlying measurement logs to reduce data volume.

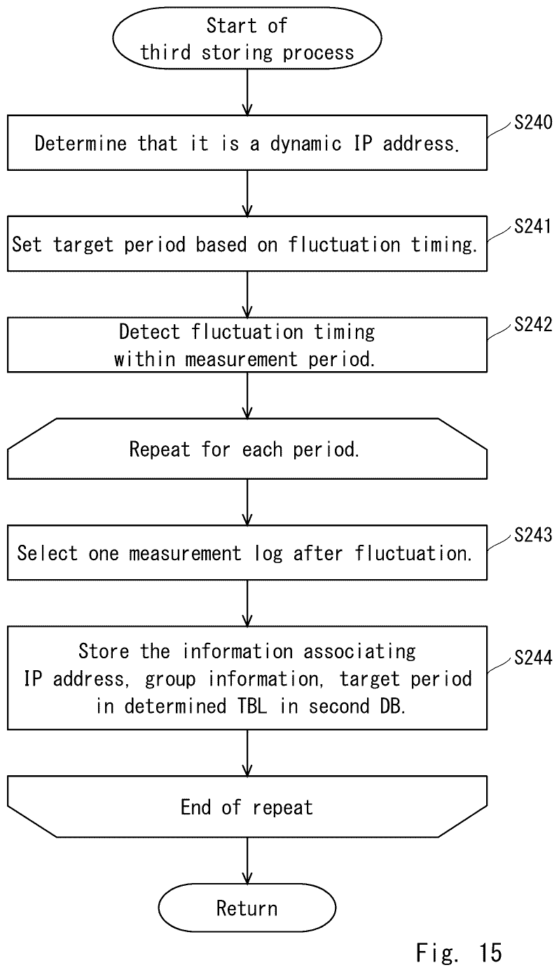

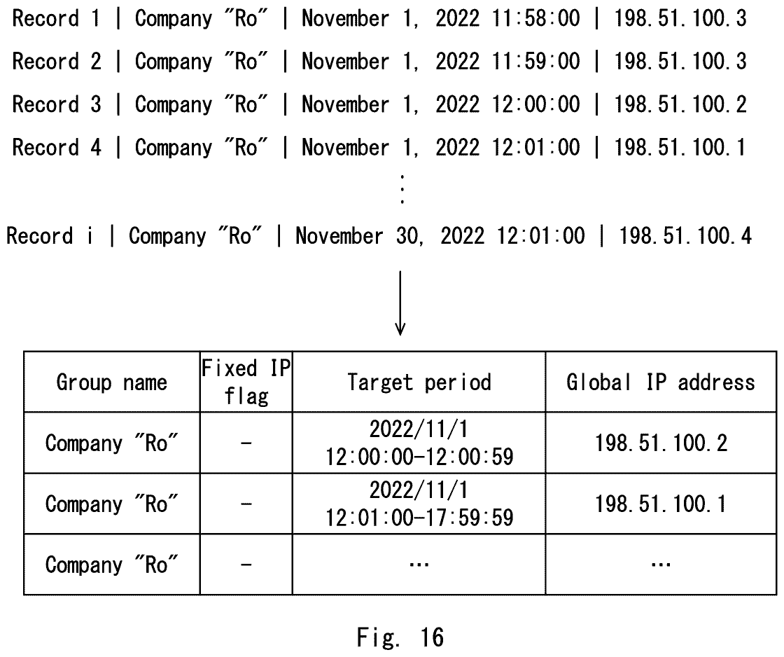

FIG. 15 is a flowchart showing the flow of the third storing process by the control unit 11 according to Embodiment 2. FIG. 16 shows the concept of the third storing process according to Embodiment 2.

The estimation unit 113 determines whether there is a fluctuation in the IP address within the measurement period, and if there is a fluctuation in the IP address, it determines that it is a dynamic IP address (S240). As shown in FIG. 16, for example, the measurement period is from Nov. 1, 2022 to Nov. 30, 2022. As shown in FIG. 16, there is a dynamic address fluctuation in the IP address of the company “Ro” within the measurement period. Therefore, the estimation unit 113 turns off the fixed IP flag.

The estimation unit 113 then detects the fluctuation timing within the measurement period (S241). Next, the estimation unit 113 sets the target period based on the fluctuation timing (S242). As shown in FIGS. 16, 12:00:00 on Nov. 1, 2022 and 12:01:00 on Nov. 1, 2022, when the IP address switches, is the fluctuation timing. The estimation unit 113 sets 12:00:00 on Nov. 1, 2022 to 12:00:59 on Nov. 1, 2022 and 12:01:00 on Nov. 1, 2022 to 17:59:59 on Nov. 1, 2022 as the target periods for each record.

The control unit 11 repeats the process shown in S243-S244 for each record, i.e., for each target period. In S243, the registration unit 114 selects one measurement log after the fluctuation in the measurement logs within the measurement period. The registration unit 114 may select the measurement log immediately after the fluctuation occurs, or it may select any measurement log within the period from the moment of fluctuation until the next fluctuation occurs.

Then, in S244, the registration unit 114 stores, in the determined table 1620 of the second DB 162, information that associates the IP address included in the selected measurement log, the retrieved group information, and the target period as a single new record. Therefore, the registration unit 114 omits the generation of records for the IP addresses included in the measurement logs that are not selected. This makes it possible to complement logs for dates and times with no measurement records while reducing data volume stored in the determined table 1620.

The registration unit 114 may select a plurality of measurement logs after the fluctuation in the measurement period and store them together with the retrieved group information in the determined table 1620 as multiple records. In this case, the number of records can be smaller than the number of selected measurement logs to reduce data volume.

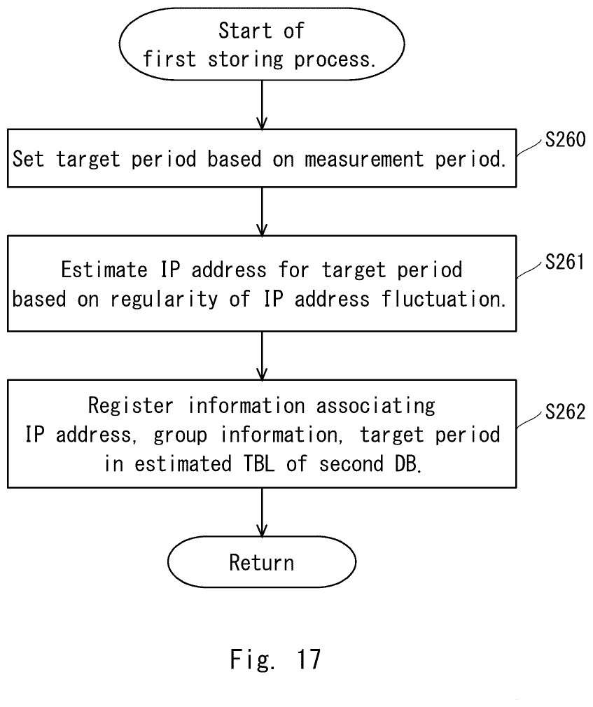

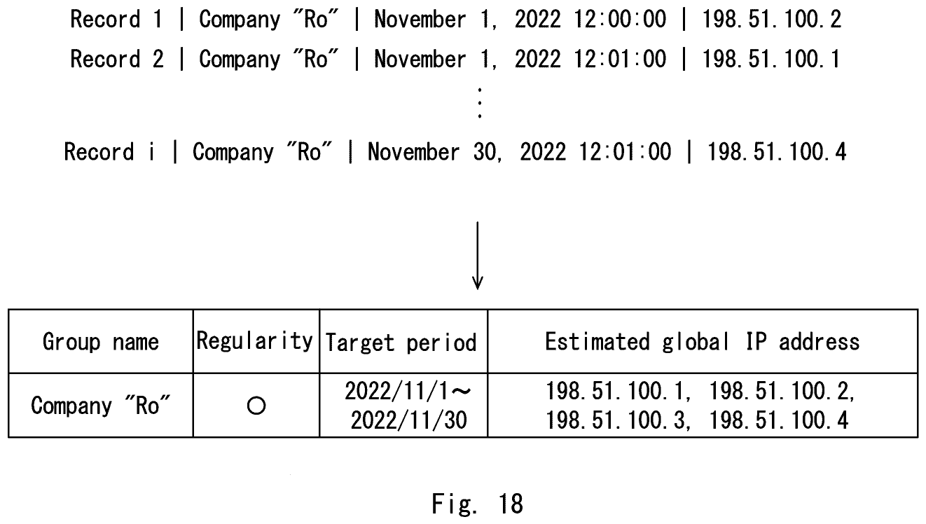

FIG. 17 is a flowchart showing the flow of the first storing process by the control unit 11 according to Embodiment 2. FIG. 18 is a diagram showing the concept of the first storing process according to Embodiment 2.

First, the estimation unit 113 sets the target period based on the measurement period (S260). In the example shown in FIG. 18, the estimation unit 113 sets the same period as the measurement period, as the target period (Nov. 1, 2022 to Nov. 30, 2022). However, it is not limited to this, for example, the registration unit 114 may set the target period to one month in the future, several months ahead of the measurement period.

Next, the estimation unit 113 estimates the IP address for the target period based on the regularity of the dynamic IP address fluctuation determined in S25 (S261). For example, the estimation unit 113 may estimate the IP address based on at least one of the number of appearance of the same IP address, the period of appearance of the same IP address, and the dynamic address range of the IP address. For example, the estimation unit 113 may estimate the IP address for the target period based on the regularity according to the identified ISPs. For example, the estimation unit 113 may generate a regression equation between the IP address and the date and time in the target period to estimate the IP address for the target period.

The registration unit 114 then stores, in the second DB162, information that associates the IP address estimated in S261, the group information retrieved in S21, and the target period(S262). By implementing such a method, the information processing apparatus 10 can easily identify the correspondence between the group and the dynamic IP address.

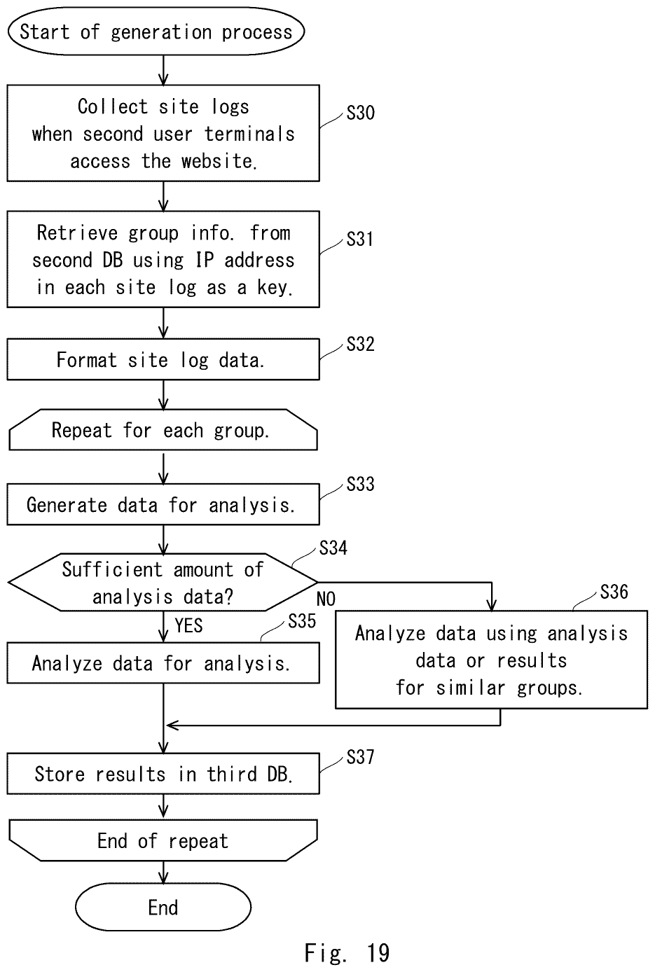

FIG. 19 is a flowchart showing the flow of the generation process by the control unit 11 according to Embodiment 2.

First, the second acquisition unit 115 collects, from the log collection server 40, site logs of when the second user terminal 30 accesses the website (S30: second acquisition step). Next, the generating unit 116 retrieves group information from the determined table 1620 or estimated table 1621 of the second DB 162 using the IP address and the access date and time included in each site log as keys (S31). Here, for addresses that are dynamic IP addresses with regularities in the fluctuations, there are records in both the determined table 1620 and the estimated table 1621. The generation unit 116 may determine whether to retrieve in the determined table 1620 or the estimated table 1621, depending on the required analysis accuracy.

Next, the generation unit 116 formats the site log data so that each site log includes at least the access date and time, the group information retrieved in S31, and the session ID (S32). For example, the generation unit 116 adds the group information to the site log. In S32, the generating unit 116 may format the data of the site log to include a user ID or a terminal ID instead of or in addition to the session ID.

Next, the control unit 11 repeats the process shown in S33 to S37 for each group. In S33, the generation unit 116 collects the formatted data of the same group and generates data for analysis that includes the collected formatted data (S33: generation step).

Next, the analysis unit 117 determines whether the amount of data for analysis corresponding to one group is sufficient (S34). Here, the analysis unit 117 determines that the amount of data for analysis is sufficient if the number of formatted data included in the data for analysis (i.e., the number of site logs underlying the data for analysis) for one group is greater than or equal to a predetermined number. Alternatively, the analysis unit 117 may determine that the amount of data for analysis is sufficient if the number of formatted data included in the data for analysis for one group and for one parameter is greater than or equal to a predetermined number.

If the analysis unit 117 determines that the amount of data for analysis corresponding to one group is sufficient (YES in S34), it analyzes the data for analysis corresponding to the group (S35).

On the other hand, if the analysis unit 117 does not determine that the amount of data for analysis corresponding to one group is sufficient (NO in S34), it analyzes the data for analysis using data or results for analysis of groups similar to that group (S36). The similarity of groups may be determined based on the attribute information of the groups, such as their industry, customer base, profitability, market share, and organizational structure. As an example, group “A” and group “B”, which belong to the same automobile industry and have the attribute of surplus, are recognized as similar companies, although they are different from each other. Therefore, the analysis unit 117 performs the analysis by complementing the lacking data in group “B” with data for group “A”.

The analysis unit 117 then stores the analysis results in the third DB 163 (S37 ). The analysis unit 117 may transmit the analysis results to the advertiser's apparatus 50.

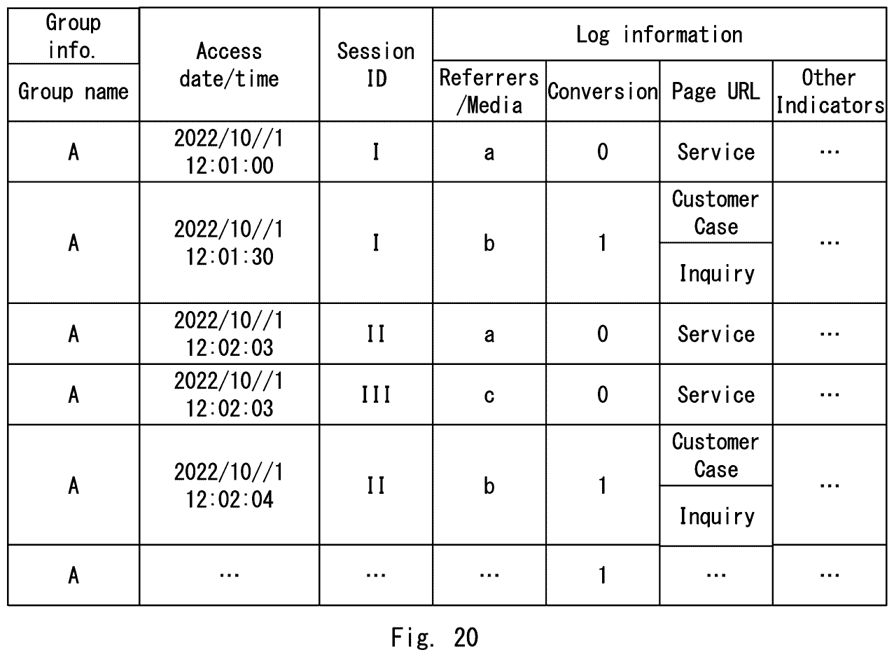

FIG. 20 is a diagram showing a first example of the data structure of the data for analysis according to Embodiment 2. As an example, log information included in the site log includes referrers/media, conversion, page URL, and other indicators. The referrers/media is information indicating from which website or media the user accessed the target website, in other words, it serves as referrers information.

The generation unit 116 generates formatted data with the group information added to the site log in S32. Then, the generation unit 116 generates a set of formatted data filtered by the group name of group “A” in S33 as data for analysis.

The analysis unit 117 analyzes the data for analysis for each group in S35. As an example, the analysis unit 117 calculates a score for each referring media based on conversions in the data for analysis for group “A.”

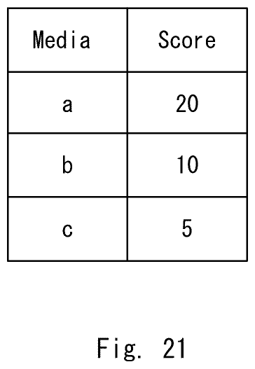

FIG. 21 is a diagram showing the first example of the data structure of the analysis results according to Embodiment 2. The magnitude of the score indicates the level of conversions achieved by the media. According to this figure, when delivering advertisements to employees of group “A”, it is most effective to deliver advertisements through media “a”.

Thus, the analysis unit 117 can identify effective media as advertisements for the group through analysis of data for analysis.

If the data for analysis for group “B” lacks data on media “c” conversions, the analysis unit 117 may substitute the score of media “c” for group “A”, a similar company, as the score of media “c” for group “B”.

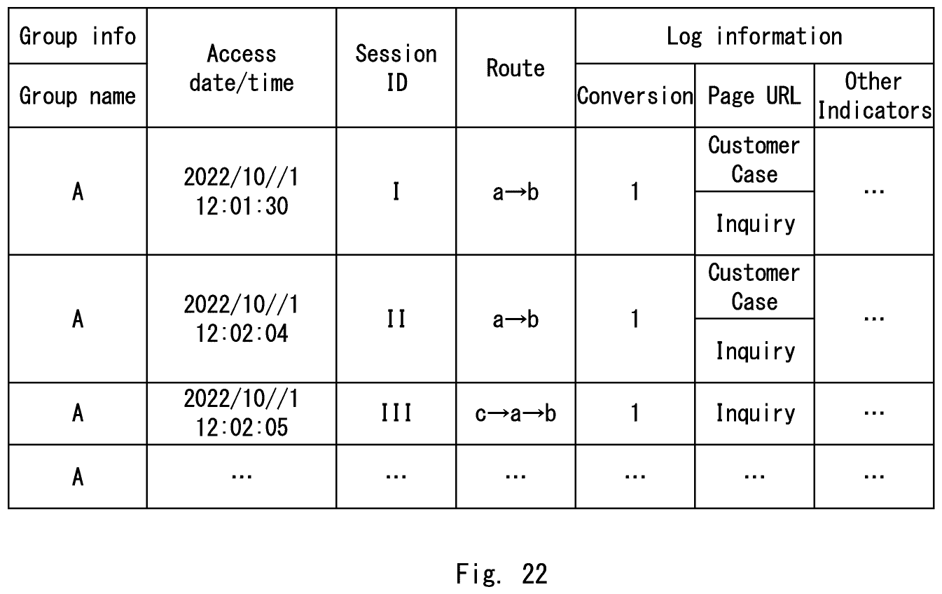

FIG. 22 is a diagram showing the second example of the data structure of data for analysis according to Embodiment 2. The generation unit 116 further filters by session ID the set of formatted data filtered by group name, group “A”, in S33 to identify the access route from the transition of the referring media.

The generation unit 116 then collects the access date and time, session ID, access route, and other log information for each group, and generates the collected data as the data for analysis.

The analysis unit 117 analyzes the data for analysis for each group in S35. As an example, the analysis unit 117 calculates a score for each access route based on conversions in the data for analysis for group “A”.

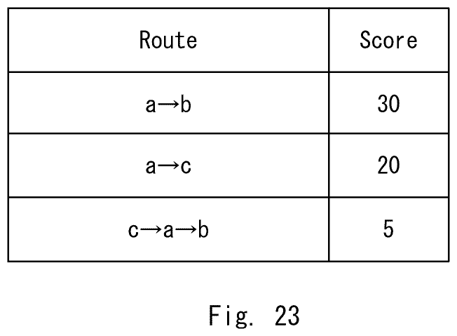

FIG. 23 is a diagram showing the second example of the data structure of the analysis results according to Embodiment 2.

The magnitude of the score indicates the level of conversion associated with the access route. According to this figure, when delivering advertisements to employees of group “A”, it is most effective to deliver advertisements in the form of directing them from media “a” to media “b”.

### Advantageous Effects

Embodiment 2 has the same advantageous effects as Embodiment 1.

The control unit 11 of the information processing apparatus 10 stores the information that associates at least the IP address with the group information as a single record when there is no fluctuation in the IP address within the measurement period in the plurality of measurement logs. This makes it possible to reduce data volume stored in the determined table 1620.

When there is a fluctuation in IP address within a measurement period in the plurality of measurement logs, the control unit 11 of the information processing apparatus 10 stores information that associates at least the IP address included in the measurement logs in which a fluctuation of occurred with the group information as a single record for each fluctuation. This makes it possible to reduce data volume stored in the determined table 1620.

According to Embodiment 2, since the correspondence between a group and a global IP address can be easily identified, it is easy to analyze access to an advertiser's website per group. Also, since the accuracy of the correspondence between a group and a global IP address is enhanced according to Embodiment 2, the accuracy of access analysis to advertisers'websites per group is enhanced.

The measurement log DB 160, the first DB 161, the second DB 162, and the third DB 163 are assumed to be included in the storage unit 16 of the information processing apparatus 10, but may be included in an external device accessible by the information processing apparatus 10.

### Embodiment 3

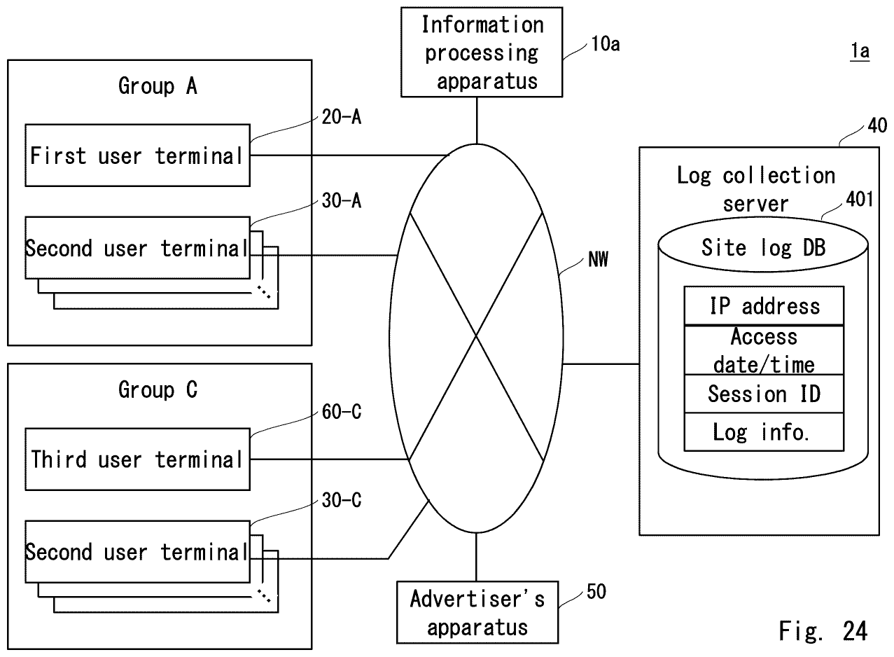

Next, Embodiment 3 of the present disclosure is described. FIG. 24 is a block diagram showing the schematic structure of the system la according to Embodiment 3. System la has basically the same configuration as System 1. However, system la differs from system 1 in that it has an information processing apparatus 10a, a third user terminal 60-C, and a second user terminal 30-C instead of information processing apparatus 10.

Group “C” is a group that is different from, but similar to, group “A”. More specifically, group “C” is a group whose similarity to group “A” exceeds a predetermined threshold. The similarity of groups may be determined based on the attribute information of the groups, such as their industry, customer base, profitability, market share, and organizational structure.

The third user terminal 60-C is an image forming device such as a multifunctional printer, a wireless LAN router, or a smart speaker installed in group “C”. The third user terminal 60-C is a terminal to which a unique ID is set, but unlike the first user terminal 20, it does not have a function to deliver advertisements. As an example, the third user terminal 60-C is a multifunctional printer without signage.

The second user terminal 30-C is also referred to as the fourth user terminal. The second user terminal 30-C is the second user terminal 30 used by users belonging to group “C”. The second user terminal 30-C has no unique ID set.

Information processing apparatus 10a differs from information processing apparatus 10 in that it has a control unit 11a instead of a control unit 11.

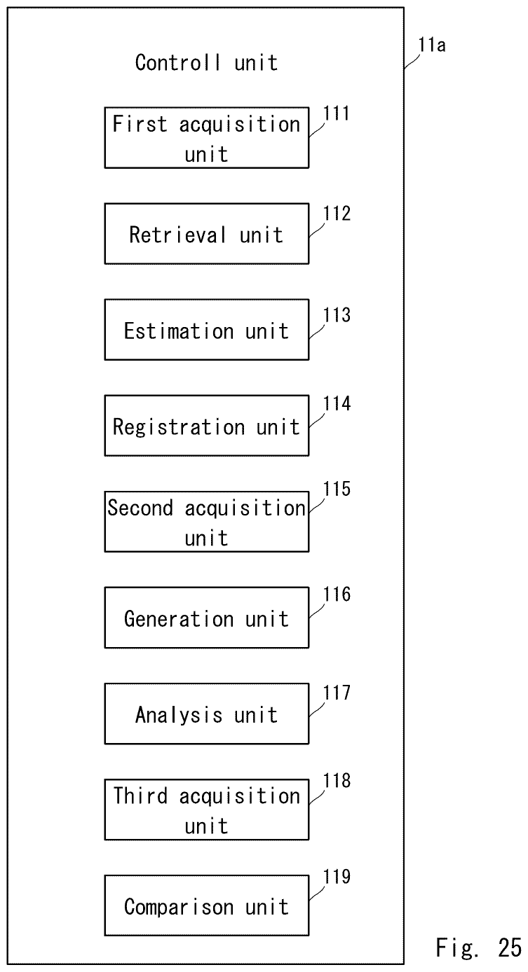

FIG. 25 is a diagram showing an example of the functional configuration of the control unit 11a according to Embodiment 3. In addition to the configuration of control unit 11, control unit 11a has a third acquisition unit 118 and a comparison unit 119.

The third acquisition unit 118 receives and acquires the delivery log from the first user terminal 20 via the communication unit 15. The delivery log is also referred to as the third log. The delivery log is a log regarding the delivery of advertising data from the first user terminal 20 and includes information regarding the date and time of delivery and the delivered contents.

When the delivered contents corresponding to the delivery log are associated with a predetermined group, the comparison unit 119 compares the delivery date and time with the access date and time contained in the site log. The predetermined group may be advertisers. When the comparison results satisfy the predetermined conditions, the comparison unit 119 determines that the delivery is effective.

For example, the predetermined condition may be that the delivery date and time is before the access date and time. For example, the predetermined condition may include, in addition to the above conditions, at least one of the following: the period between the delivery date and time and the access date and time is within the predetermined period, and a conversion has occurred. This makes it easy to measure the effectiveness of advertisement delivery based on the relationship between advertisement delivery and access.

The comparison unit 119 also compares the log information in the site log when the second user terminal 30-A in group “A” accesses the advertiser's website with the log information in the site log when the second user terminal 30-C in group “C” accesses the advertiser's website. This makes it easy to measure the effectiveness of advertisement delivery based on the presence or absence of advertisement delivery. The site log when the second user terminal 30-C accesses the advertiser's website is also referred to as the fourth log. The step in which the second acquisition unit 115 acquires the fourth log is also referred to as the fourth acquisition step.

The comparison unit 119 then transmits the various comparison results to the advertiser's apparatus 50. This make it possible to provide feedback on the effectiveness of advertisement delivery to the advertiser.

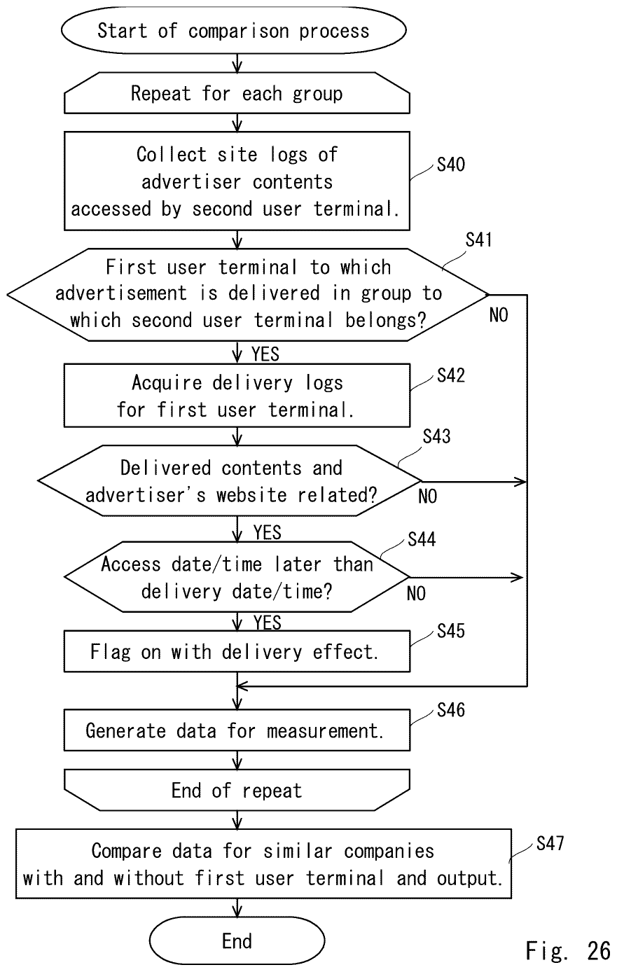

FIG. 26 is a flowchart showing the flow of the comparison process by the control unit 11a according to Embodiment 3. First, the control unit 11a repeats the process shown in S40-S46 for each group. In S40, the third acquisition unit 118 collects a site log from the log collection server 40 when the second user terminal 30 accesses the advertiser's contents.

Next, the comparison unit 119 determines whether the first user terminal 20 to which the advertisement is delivered is installed in the place of the group to which the second user terminal 30 belongs (S41). Specifically, the comparison unit 119 identifies the group using the second DB 162 based on the IP address and access date and time in the site log. The comparison unit 119 then retrieves the first DB 161 using the group information as a key, and determines that, if there is a corresponding unique ID, the first user terminal 20 is installed.

If the first user terminal 20 is not installed in the place of the group (NO in S41), the comparison unit 119 proceeds with the process to S46. On the other hand, if the comparison unit 119 determines that the first user terminal 20 is installed at the place of the group (YES in S41), the third acquisition unit 118 acquires the delivery log from the first user terminal 20 (S42: third acquisition step).

Next, the comparison unit 119 determines whether the delivered contents included in the advertisement data are related to the content of the advertiser's website (S43). Specifically, the comparison unit 119 makes the above determination based on whether the degree of relation between the attribute information of the delivered contents and the attribute information of the advertiser's website contents is greater than a predetermined value. If the delivered contents and the advertiser's website contents are not related (NO in S43), the control unit 11a proceeds with the process to S46.

On the other hand, if the delivered contents are related to the advertiser's website contents (YES in S43), the comparison unit 119 determines whether the access date and time in the site log is later than the delivery date and time in the delivery log (S44: determination step). If the access date and time is not later than the delivery date and time in the delivery log (NO in S44), the control unit 11a proceeds with the process to S46.

On the other hand, if the access date and time is later than the delivery date and time in the delivery log (YES in S44), the comparison unit 119 turns on the flag with delivery effect (S45).

Then, in S46, the comparison unit 119 generates data for measurement.

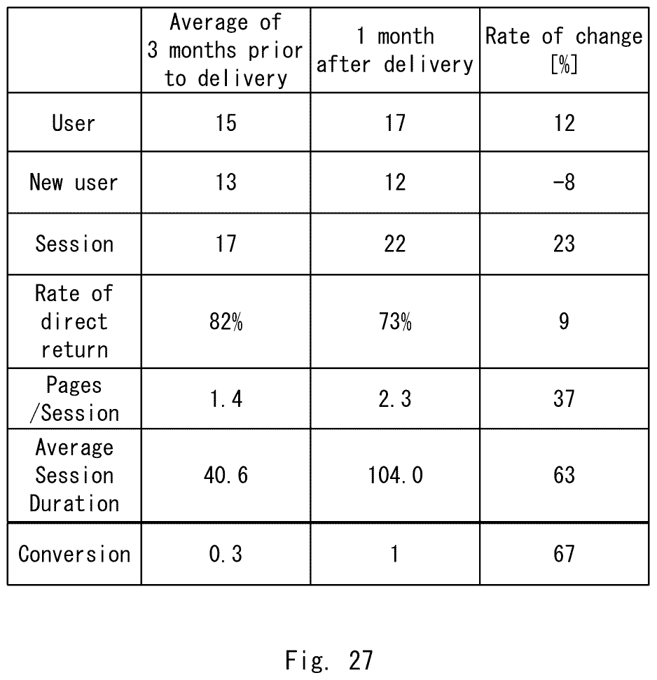

FIG. 27 is a diagram showing an example of the data structure of the data for measurement according to Embodiment 3. The comparison unit 119 calculates, as data for measurement, the value of the indicator indicating the delivery effect based on log information, separately before and after delivery. The comparison unit 119 also includes the rate of change of the indicator before and after delivery in the data for measurement.

In S47, the comparison unit 119 compares the data for measurement of similar companies with and without the first user terminal 20 installed (comparison step). For example, the comparison unit 119 compares the data for measurement for group “A”, in which the first user terminal 20 is installed, with the data for measurement for group “C”, in which the first user terminal 20 is not installed. The comparison unit 119 then outputs the comparison results to the advertiser's apparatus 50 (output step).

### Advantageous Effects

Embodiment 3 has the same advantageous effects as Embodiments 1 and 2.

The control unit 11a of the information processing apparatus 10a determines that the delivery is effective when the delivery contents corresponding to the delivery log are related to the advertiser's website contents and were accessed after delivery. This makes it easy to measure the effectiveness of advertisement delivery based on the relationship between advertisement delivery and access.

The control unit 11a of the information processing apparatus 10a also compares the log information with and without advertisement delivery. This makes it easy to measure the effectiveness of advertisement delivery based on the presence or absence of advertisement delivery.

### Other Embodiments

Although the case of a single device as information processing apparatuses 10, 10a is described in Embodiments 1-3, some or all of the components of the information processing apparatuses 10, 10a may be realized by a plurality of information processing apparatuses, circuits, etc. In this case, the plurality of information processing apparatuses and circuits, etc. may be centrally located or delivered. For example, the information processing apparatuses and circuits may be realized as a client-server system, cloud computing system, etc., each of which is connected via a communication network. The functions of the information processing apparatuses 10, 10a may be provided in a Saas (Software as a Service) format.

Although the disclosure has been described above with reference to embodiments, the disclosure is not limited by the above. Various changes can be made to the configuration and details of the disclosure that can be understood by those skilled in the art within the scope of the invention.

For example, in Embodiments 2-3, the first user terminal 20 is a multifunctional printer with signage, but it is not limited to this. As an example, the first user terminal 20 may be any other image forming device, wireless LAN router, smart speaker, or other communication device with an external signage. As an example, the first user terminal 20 may be a terminal with communication functions integrated with the signage.

In the embodiments described above, the program can be stored and supplied to a computer using various types of non-transitory computer readable medium. Non-transitory computer readable media include various types of tangible storage medium. Examples of non-transitory computer readable media include magnetic storage media (e.g., flexible disks, magnetic tape, hard disk drives), magneto-optical storage media (e.g., magneto-optical disks), CD-ROM (Read Only Memory), CD-R, CD-R/W, DVD (Digital Versatile Disc), semiconductor memory (e.g., mask ROM, PROM (Programmable ROM), EPROM (Erasable PROM), flash ROM, RAM (Random Access Memory). Programs may also be supplied to a computer by various types of transitory computer readable medium (transitory computer readable medium). Examples of transitory computer readable media include electrical signals, optical signals, and electromagnetic waves. A transitory computer readable medium can provide a program to a computer via wired or wireless communication paths, such as wires and optical fiber.

Some or all of the above embodiments may also be described as, but not limited to, the following appendix.

### Appendix 1

An information processing system comprising a control unit, wherein
the control unit is configured to perform:
a first acquisition step of acquiring a plurality of first logs including at least an IP address and a date and time from a first user terminal to which a unique ID is set;
a retrieval step of retrieving group information from a first database that stores the unique ID and the group information by using the unique ID of the first user terminal as a key;
a estimation step of estimating the IP address for a target period based on a regularity of a fluctuation in the IP address if there is the fluctuation in the IP address within a predetermined period in the plurality of the acquired first logs; and
a first storing step of storing, in a second database, information that associates at least the estimated IP address with the retrieved group information.

### Appendix 2

The information processing system according to Appendix 1, wherein the control unit is configured to further perform a second storing step of storing the information that associates at least the IP address with the retrieved group information as a single record in the second database if the IP address has not fluctuated within a predetermined period in the plurality of acquired first logs.

Information processing system as described in Appendix 1.

### Appendix 3

The information processing system according to Appendix 1 or 2, wherein the control unit is configured to further perform a third storing step of storing, if there is the fluctuation in the IP address within the predetermined period of time in the plurality of the acquired first logs, in the second database at least the information that associates the IP address in the first log in the predetermined period in which the fluctuation in the IP address is occurred with the retrieved group information.

### Appendix 4

The information processing system according to any one of Appendixes 1 to 3, wherein the control unit is configured to determine, in the estimation step, whether there is the regularity of the fluctuation based on at least one of the following: the number of times the same IP address appears within the predetermined period, a periodicity of appearance of the same IP address, and a range of fluctuation in the IP address.

### Appendix 5

The information processing system according to any one of Appendixes 1 to 4, wherein the control unit is configured to further perform:
a second acquisition step of acquire a second log including at least an IP address of a second user terminal to which no unique ID is set of when the second user terminal accesses a website, and log information on the web browsing, and an access date and time;
a generation step of identifying, from the second database, group information associated with the IP address included in the second log and corresponding to the access date and time; and
generating, as data for analysis, information that associates at least the log information on the web browsing, the access date and time, and the identified group information.

### Appendix 6

The information processing system according to Appendix 5, wherein the log information on the web browsing includes information indicating a referrer and a conversion, and
the control unit further performing
identifying effective media or access routes as advertisements for the group based on the log information associated with group information for the group in the data for analysis.

### Appendix 7

The information processing system according to any one of Appendixes 1 to 4, wherein the control unit is configured to further perform:
a second acquisition step of acquiring a second log including the IP address of when a second user terminal accesses a website, log information on the web browsing, and an access date and time;
a third acquisition step of acquiring, if the first user terminal has a function to deliver advertisements, a third log on the delivery of advertisements, the third log including information about a delivery date and time and delivery contents;
determination step of comparing e, if the delivered contents corresponding to the third log is related to the website, the delivery date and time with the access date and time included in the second log; and
determining that the delivery is effective if the comparison result satisfies predetermined conditions, wherein
the second user terminal is a terminal used by a user belonging to a group to which the first user terminal belongs, and to which no unique ID is set.

### Appendix 8

The information processing system according to any one of Appendixes 1 to 4, wherein the control unit is configured to further perform:
a second acquisition step of acquiring a second log including an IP address of when a second user terminal accesses a website, log information on the web browsing, and an access date and time;
a fourth acquisition step of acquiring a fourth log including an IP address of when a fourth user terminal accesses a website, log information on the web browsing, and an access date and time;
a comparison step of comparing the log information included in the second log with the log information included in the fourth log; and
an output step of outputting the comparison results, wherein
the second user terminal is a terminal used by a user belonging to a group to which the first user terminal belongs, and to which no unique ID is set, and
the fourth user terminal is a terminal used by a user belonging to a group different from the group to which the first user terminal belongs, and to which no unique ID is set.

### Appendix 9

An information processing method executed on a computer comprising a control unit, the method comprising:
a first acquisition step of acquiring a plurality of first logs including at least an IP address and a date and time from a first user terminal to which a unique ID is set;
a retrieval step of retrieving group information from a first database that stores the unique ID and the group information by using the unique ID of the first user terminal as a key;
a estimation step of estimating the IP address for a target period based on a regularity of a fluctuation in the IP address if there is the fluctuation in the IP address within a predetermined period in the plurality of the acquired first logs; and
a first storing step of storing, in a second database, information that associates at least the estimated IP address with the retrieved group information.

### Appendix 10

Program comprising instructions that, when executed by a computer, cause the computer to:
a first acquisition step of acquiring a plurality of first logs including at least an IP address and a date and time from a first user terminal to which a unique ID is set;
a retrieval step of retrieving group information from a first database that stores the unique ID and the group information by using the unique ID of the first user terminal as a key;
a estimation step of estimating the IP address for a target period based on a regularity of a fluctuation in the IP address if there is the fluctuation in the IP address within a predetermined period in the plurality of the acquired first logs; and
a first storing step of storing, in a second database, information that associates at least the estimated IP address with the retrieved group information.

### REFERENCE SIGNS LIST

1,1a system
10,10a information processing apparatus
11 control unit
12 processor
13 ROM
14 RAM
15 communication unit
16 storage unit
17 input unit
18 display unit
20 first user terminal
21 control unit
22 processor
23 ROM
24 RAM
25 communication unit
26 storage unit
27 input unit
28 display unit
29 output unit
30 second user terminal
31 control unit
32 processor
33 ROM
34 RAM
35 communication unit
36 storage unit
37 input unit
38 display unit
40 Log collection server
50 advertiser's apparatus
60 third user terminal
111 first acquisition unit
112 retrieval unit
113 estimation unit
114 registration unit
115 second acquisition unit
116 generation unit
117 analysis unit
118 third acquisition unit
119 comparison unit
160 measurement log DB
161 first DB
162 second DB
163 third DB
401 site log DB
1620 determined table
1621 estimated table
NW network

1. An information processing system, comprising:
one or more processors;
a memory; and
one or more programs, wherein
the one or more programs are stored in the memory and configured to be executed by the one or more processors to cause the information processing system to:
acquire a plurality of first logs including at least an IP address and a date and time from a first user terminal to which a unique ID is set;
retrieve group information from a first database that stores the unique ID and the group information by using the unique ID of the first user terminal as a key;
estimate the IP address for a target period based on a regularity of a fluctuation in the IP address if there is the fluctuation in the IP address within a predetermined period in the plurality of the acquired first logs; and
store, in a second database, information that associates at least the estimated IP address with the retrieved group information.

2. The information processing system according to claim 1, wherein the one or more programs further comprising instructions to store the information that associates at least the IP address with the retrieved group information as a single record in the second database if the IP address has not fluctuated within a predetermined period in the plurality of acquired first logs.

3. The information processing system according to claim 1, wherein the one or more programs further comprising instructions to store, if there is the fluctuation in the IP address within the predetermined period of time in the plurality of the acquired first logs, in the second database at least the information that associates the IP address in the first log in the predetermined period in which the fluctuation in the IP address is occurred with the retrieved group information.

4. The information processing system according to claim 1, wherein the one or more programs further comprising instructions to determine, in the estimating, whether there is the regularity of the fluctuation based on at least one of the following: the number of times the same IP address appears within the predetermined period, a periodicity of appearance of the same IP address, and a range of fluctuation in the IP address.

5. The information processing system according to claim 1, wherein the one or more programs further comprising instructions to:
acquire a second log including at least an IP address of a second user terminal to which no unique ID is set of when the second user terminal accesses a website, and log information on the web browsing, and an access date and time;
identify, from the second database, group information associated with the IP address included in the second log and corresponding to the access date and time; and
generate, as data for analysis, information that associates at least the log information on the web browsing, the access date and time, and the identified group information.

6. The information processing system according to claim 5, wherein the log information on the web browsing includes information indicating a referrer and a conversion, and
the one or more programs further comprising instructions to
estimate, for each group, a level of the conversion when delivered as an advertisement for the group, for each media or access route, based on the log information associated with the group information for the group in the data for analysis.

7. The information processing system according to claim 1, wherein the one or more programs further comprising instructions to:
acquire a second log including the IP address of when a second user terminal accesses a website, log information on the web browsing, and an access date and time;
acquire, if the first user terminal has a function to deliver advertisements, a third log on the delivery of advertisements, the third log including information about a delivery date and time and delivery contents;
compare, if the delivered contents corresponding to the third log is related to the website, the delivery date and time with the access date and time included in the second log; and
determine that the delivery is effective if the comparison result satisfies predetermined conditions, wherein
the second user terminal is a terminal used by a user belonging to a group to which the first user terminal belongs, and to which no unique ID is set.

8. The information processing system according to claim 1, wherein the one or more programs further comprising instructions to:
acquire a second log including an IP address of when a second user terminal accesses a website, log information on the web browsing, and an access date and time;
acquire a fourth log including an IP address of when a fourth user terminal accesses a website, log information on the web browsing, and an access date and time;
compare the log information included in the second log with the log information included in the fourth log; and
output the comparison results, wherein
the second user terminal is a terminal used by a user belonging to a group to which the first user terminal belongs, and to which no unique ID is set, and
the fourth user terminal is a terminal used by a user belonging to a group different from the group to which the first user terminal belongs, and to which no unique ID is set.

9. An information processing method executed on a computer, the method comprising:
acquiring a plurality of first logs including at least an IP address and a date and time from a first user terminal to which a unique ID is set;
retrieving group information from a first database that stores the unique ID and the group information by using the unique ID of the first user terminal as a key;
estimating the IP address for the target period based on a regularity of a fluctuation in the IP address if there is the fluctuation in the IP address within a predetermined period in a plurality of the acquired first logs; and
Storing, in a second database, information that associates at least the estimated IP address with the retrieved group information.

10. A non-transitory computer readable storage medium storing one or more programs comprising instructions that, when executed by a computer, cause the computer to:
acquire a plurality of first logs including at least an IP address and a date and time from a first user terminal to which a unique ID is set;
retrieve group information from a first database that stores the unique ID and the group information by using the unique ID of the first user terminal as a key;
estimate the IP address for the target period based on a regularity of a fluctuation in the IP address if there is the fluctuation in the IP address within a predetermined period in a plurality of the acquired first logs; and
Store, in a second database, information that associates at least the estimated IP address with the retrieved group information.
